(19) United States
(12) Patent Application Publication
(10) Pub. No.: US 2010/0105264 A1
(43) Pub. Date: Apr. 29, 2010

(54) GASKET RELEASE AGENT

(76) Inventors: Tim Pistner, Fairport, NY (US); Howard Lockhart, Rochester, NY (US); Ameet Kulkarni, Fairport, NY (US)

Correspondence Address: HOLLAND & HART, LLP, P.O BOX 8749, DENVER, CO, 80201, US

(21) Appl. No.: 12/259,162

(22) Filed: Oct. 27, 2008

(51) Int. Cl. B32B 9/04; B05D 1/00; B32B 17/06; B32B 27/00; B32B 29/00; B32B 5/02; B32B 9/06; B32B 27/32; B32B 15/04

(52) U.S. Cl. 442/59; 427/331; 428/457; 428/455; 428/408; 428/427; 428/523; 428/422; 428/446; 428/450; 428/451; 428/428; 428/532; 428/484.1

(57) ABSTRACT

Various gasket release agents and methods of providing and using the same are provided with a gasket body having a release agent coating on one or more surfaces that contact mating surfaces of a joining assembly. The coating may be provided as a mixture of constituents including hexagonal boron nitride. Other constituents may include a release agent and a binding material that enhances the adhesion of the release agent to the gasket body surfaces. A binding material may include, for example, organic or inorganic materials. Surfactants, in some embodiments, may be added to a gasket release agent dispersion in addition to binder materials and fillers.

### CROSS-REFERENCE TO RELATED PATENT APPLICATIONS

The invention claims priority from U.S. Provisional Patent Application No. 60/983,846 entitled GASKET RELEASE AGENT by Tim Pistner, Howard Lockhart, and Ameet Kulkarni, filed on Oct. 30, 2007, which Provisional Patent Application is hereby incorporated by reference in its entirety.

### BACKGROUND

Gaskets are well known and used in a variety of fluid applications to seal joints, valves, and other openings. Gaskets may also be used in various other applications, such as applications requiring vibration isolation, and/or sound isolation, for example. Such applications often involve two surfaces, referred to as mating surfaces that are fitted together with a gasket in between, completing a seal between the two surfaces.

Routinely, the surfaces must be separated, such as for maintenance or repair of a joint or valve. In such cases, it is often required that the gasket material between the surfaces be removed, the mating surfaces cleaned, a new gasket installed, and the surfaces again mated. Upon removal of the gasket from its application point there is a potential for residue to be left behind. Such residue is often required to be removed prior to installation of a new gasket in its joining assembly, ensuring a tight seal. Furthermore, in some cases, excessive effort is required to separate the surfaces between which the gasket resides. This may be due to a number of factors, such as bonding of the gasket material to mating surfaces, which can result in a significant amount of force being required to separate the two surfaces.

Previous attempts at providing gasket release agents have used graphite. However, in such applications, some of the graphite typically transferred to the sealing surface, which limited its uses. Another problem with the use of graphite as a release agent was that the coefficient of friction for graphite would increase exponentially with increases in temperature. Moreover, the processing and handling of graphite has been typically messy. The black color of the graphite made such applications unsightly, limited the applications in which it could be used, and prevented color-branding of the release agents or substrates on which the release agents reside.

### SUMMARY

This Summary is provided to introduce a simplified selection of some concepts that are further described below in the Detailed Description. This Summary and the Background are not intended to identify key aspects or essential aspects of the claimed subject matter. Moreover, this Summary is not intended for use as an aid in determining the scope of the claimed subject matter.

Various embodiments of coated gaskets and methods of providing and using the same are provided. In some embodiments, a gasket body is provided with a coating of release agent on both surfaces of the gasket body that contact mating surfaces of a joining assembly. Other embodiments may include a gasket body that has a coating on a single surface, or a portion of one or more surfaces. In some aspects, the gasket body may be formed of organic and inorganic non-metallic and metallic gasket body materials, such as, for example, gasket paper, elastomers, stainless steel, cork, felt, graphite, fiberglass, and/or a polymer such as polytetrafluoroethylene, polypropylene, and the like. In some embodiments, the gasket body includes reinforcing materials as well.

The coating, in some embodiments, is a release agent that enhances the removal of the gasket after installation in a joining assembly. In particular embodiments, the coating may be provided as a mixture of constituents including, primarily, hexagonal boron nitride (BN). The coating may be applied to the gasket body by any of a number of methods, including painting, spreading, roll coating, spraying, and/or dipping. The coating may also be applied to the gasket body in a single application step, or in more than one step. In some embodiments, the release agent coating includes a number of constituents, including a release agent and a binding material that enhances the adhesion of the release agent to the gasket body surface(s). A binding material may include, for example, organic or inorganic materials. Surfactants, in some embodiments, may be added to a gasket release agent dispersion in addition to binder materials and fillers. Surfactants promote wetting of the coating material with the surface material of the gasket body. Binding agents and surfactants are dependent on the substrate. Accordingly, in some embodiments neither will be required.

A flange assembly of various embodiments may be provided to test various gaskets under simulated operating conditions in order to verify gasket performance. In one example, a coated gasket may have a coating of 100% hexagonal boron nitride. The gasket and coating may be tested at a specified bolt load and at a specified temperature to determine if the gasket releases from the flange surfaces after being exposed to the simulated operating conditions for a period of time. In particular, a coated gasket may be mounted in flange assembly between two flanges. The flanges may then be secured to one another with washers, bolts, and nuts, which arc tightened to a desired bolt load. The assembly may then be subjected to simulated operating conditions. Thereafter, the flange assembly is removed from the simulated operating conditions, and the two flanges are separated while determining the force required to separate the flanges.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a partial cross-section view of one embodiment of a coated gasket according to the present technology.

FIG. 2 depicts a plan view of a an embodiment of a coated gasket according to the present technology, in which half of the gasket body is removed to better illustrate the coating on the gasket body surfaces.

FIG. 3 depicts a perspective view of the coated gasket depicted in FIG. 2.

FIG. 4 depicts an exploded, elevation view of one embodiment of a flange assembly that may be used to test gaskets in order to verify gasket performance.

FIG. 5 depicts a perspective view of the flange assembly depicted in FIG. 4 in an assembled position.

FIG. 6 depicts a side elevation view of the flange assembly depicted in FIG. 5.

FIG. 7 depicts a top, plan view of the flange assembly depicted in FIG. 5.

### DETAILED DESCRIPTION

Embodiments are described more fully below with reference to the accompanying figures, which form a part hereof and show by way of illustration, specific exemplary embodiments. These embodiments are disclosed in sufficient detail to enable those skilled in the art to practice the technology. However, embodiments may be implemented in many different forms and should not be construed as being limited to the embodiments set forth herein. The following detailed description is, therefore, not to be taken in a limiting sense.

As discussed above, many applications require the installation and replacement of gaskets. Further, replacement often requires significant force be applied to separate mating surfaces, and also often results in significant amounts of residue left on one or more surfaces requiring significant effort to clean, and in some cases requiring replacement of one or more of the joining assembly components. The present disclosure recognizes that reductions in the amount of force required to separate the mating surface components for maintenance and repair is desirable for many reasons, including more efficient maintenance or repair operations, and safety considerations, among others. Furthermore, the present disclosure recognizes that reduction in gasket residue remaining on a mating surface after separation of housing components is desirable, in order to reduce the time required for maintenance or repair, as well as potentially reducing the number of replacement-components required in cases where a mating surface can not be adequately cleared of gasket residue. Many current methods use release agents such as graphite powder, which is suitable for some applications. Such release agents, however, are commonly messy, as the powder is black and often soils nearby items, which is often not desirable. Furthermore, such release agents can break down at relatively high temperatures, resulting in additional residue that is left on a mating surface after separation of the joining assembly components. Various embodiments of the present disclosure provide methods, systems, and apparatuses that enable gaskets to release from mating surfaces where the joining assembly is exposed to high temperatures, as well as provides a cleaner gasket for installation.

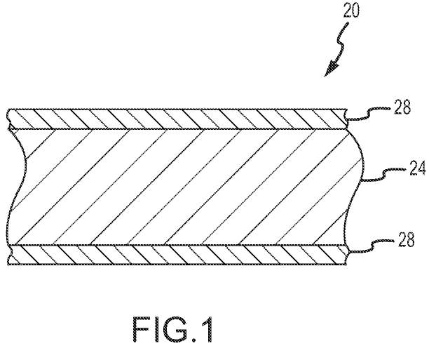

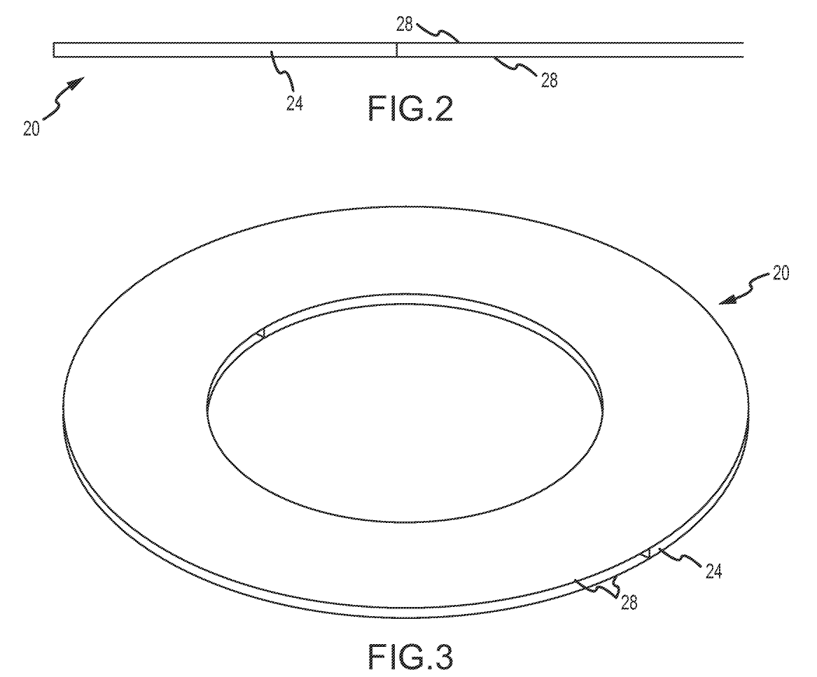

With reference to FIGS. 1-3, a coated gasket 20 of an embodiment is described. FIG. 1 illustrates a partial cross-section of a coated gasket 20 of this embodiment. In this embodiment, a gasket body 24 has a coating 28 of release agent on both surfaces of the gasket body 24 that will contact mating surfaces of a joining assembly. FIG. 2 illustrates a plan view of a coated gasket 20, in which half of the gasket body 20 is removed to better illustrate the coating 28 on the gasket body 24 surfaces. FIG. 3 illustrates a perspective view of the coated gasket 20 of FIG. 2. Other embodiments may include a gasket body 24 that has a coating 28 only on a single surface, or a portion of one or more surfaces.

The gasket body 24 may be formed of organic and inorganic non-metallic and metallic gasket body materials, such as, for example, gasket paper, elastomers, stainless steel, cork, felt, graphite, fiberglass, and/or a polymer (such as polytetrafluoroethylene, polypropylene, and etc. . . . ). As will be readily understood by one of skill in the art, the particular gasket material depends in large part on the particular application for which the gasket will be used, and is selected based on a number of factors such as required compression, operating temperatures, and the media to which the gasket is exposed. The gasket body 24 may include reinforcing materials as well, as is also well known and will be readily understood by one of skill in the art.

The coating 28, in an embodiment, is a release agent that enhances the removal of the gasket 20 after installation in a joining assembly (not shown). The coating 28, in an embodiment, is a mixture of constituents including, primarily, hexagonal boron nitride (BN). The BN is the release agent that allows the coated gasket 20 to be installed in a joining assembly, with mating surfaces, of the assembly, separated with relatively little effort and leaving relatively little residue. The coating 28 is applied to the gasket body 24 by any of a number of methods, including roll coating, spraying, and/or dipping. The coating 28 may be applied to the gasket body 24 in a single application step, or in more than one step.

In some embodiments, the release agent coating 28 includes a number of constituents, including BN that acts primarily as a release agent, and a binding material that enhances the adhesion of the BN to the gasket body 24 surface(s). A binding material may include, for example, organic materials. A binding material may also include inorganic materials, which are stable at elevated temperatures. Binding material that may enhance the performance of a gasket release coating 28 comprising BN, include but are not limited to natural and synthetic polymers (organic and inorganic) and natural and synthetic minerals. Inorganic binders and fillers that may be used in some embodiments are effective for relatively large temperature ranges, such as ambient temperature to 900° F., due to their high temperature resistance. Higher temperatures can be reached assuming the gasket body 24 itself can withstand this extreme condition. Examples of inorganic materials used as binders or fillers include, but are not limited to, silicates (colloidal silica, potassium, sodium, and lithium), oxides (aluminum, zirconium, silicon, and magnesium), phyllosilicates (talc, mica, and vermiculite), and clays (kaolin, bentonite, and halloysite). Some polymer binders or fillers include, but are not limited to, thermoplastic (polyethylene, polypropylene, polyvinyl acetate, and acrylics), fluoropolymer (polytetrafluoroethylene, fluorinated ethylene-propylene, and perfluoroalkoxy resin), thermoset (urethanes, epoxides, rubbers), naturally occurring polysaccharide media (starches, gums, and cellulose resins), waxes (beeswax, carnauba, paraffin) work well for the purpose of binding the coating to the sheet. However, as in both organic and inorganic binders, there may be a tradeoff between coating to gasket bonding and coating to flange sticking. Other polymeric binders may also be used to bind the release agent to the gasket body. Surfactants, in some embodiments, may be added to a gasket release agent dispersion in addition to binder materials and fillers. Surfactants promote wetting of the coating material with the surface material of the gasket body. Commonly used surfactants include, but are not limited to, anionic (sodium dodecyl sulfate, sodium lauryl ether sulfate, and soaps) and nonionic (polyethylene glycol octyphenyl ether, poly(ethylene oxide) and poly (propylene oxide) copolymers, alcohols, alkyl poly(ethylene oxide), and alkyl polyglucosides). Binding agents and surfactants are dependent on the substrate; in some cases neither will be required.

In various embodiments, a coating comprises a mixture of release agent, binding agent, and surfactant. The release agent comprises hexagonal boron nitride in quantities ranging from 0.01% to 100%, by volume, of the dry coating previously applied to the gasket. The binding agent and/or filler component comprises one or more of the above-noted binding and/or filler materials in quantities ranging from 0% to 80%, by volume, of the dry coating previously applied to the gasket. The surfactant comprises one or more of the above-noted surfactants in quantities ranging from 0% to 40%, by volume, of the dry coating previously applied to the gasket. The ranges described above are dependent on the surface substrate to which the coating will reside.

### EXAMPLE 1

In one example, a sheet of gasket material is formed using traditional techniques. The sheet of gasket material is fed into a roll coater that coats the gasket material with coating 28. The roll coater in this example provides a coating that comprises hexagonal boron nitride, binder material, filler material, and surfactants. The coating is a hexagonal boron nitride dispersion that initially comprises 25% (by volume) hexagonal boron nitride and 3% alumina binder. The dispersion is diluted with distilled water to contain 2.5% hexagonal boron nitride and 0.3% binder. A surfactant, Triton X-100, is also added to the diluted dispersion until the dispersion includes 1% surfactant. The dispersion, as mentioned, is applied to the gasket material using a roll coater, and the coated gasket material is placed in a drying oven to evaporate water from the dispersion. The dried coating of this example comprises a range of solids, depending on the percentage of surfactant present upon drying in an elevated temperature environment. The range of solids for the dried coating is approximately 66% to 90% hexagonal boron nitride, approximately 7% to 10% alumina, and approximately 0% to 26% Triton X-100. The coated sheet of gasket material is then cut into any desired configuration as required by the particular application for the gasket.

### EXAMPLE 2

In another example, a sheet of gasket material is formed using traditional techniques. The sheet of gasket material is fed into a roll coater that coats the gasket material with coating 28. The roll coater in this example provides a coating that comprises hexagonal boron nitride, binder material, and surfactants. The coating is a hexagonal boron nitride dispersion that comprises 40% (by volume) hexagonal boron nitride, 0% binder, and 0% surfactant, with the remainder of the dispersion being distilled water. The dispersion as mentioned is applied to the gasket material using a roll coater, and the coated gasket material is placed in a drying oven to evaporate water from the dispersion. The dried coating of this example comprises 100% hexagonal boron nitride. The coated sheet of gasket material is then cut into any desired configuration as required by the particular application for the gasket.

### EXAMPLE 3

In a third example, a sheet of gasket material is formed using traditional techniques. The sheet of gasket material is fed into a roll coater that coats the gasket material with coating 28. The roll coater in this example provides a coating that comprises hexagonal boron nitride, filler material, binder material, and surfactants. The coating is a hexagonal boron nitride dispersion that comprises 25% (by volume) hexagonal boron nitride, 20% inorganic clay filler material, 5% silicate binder, and 0% surfactant with the remainder being distilled water. The dispersion as mentioned is applied to the gasket material using a roll coater, and the coating gasket material is placed in a drying oven to evaporate water from the dispersion. The dried coating of this example comprises 50% hexagonal boron nitride, 40% inorganic clay filler, and 10% silicate binder material. The coated sheet of gasket material is then cut into any desired configuration as required by the particular application for the gasket.

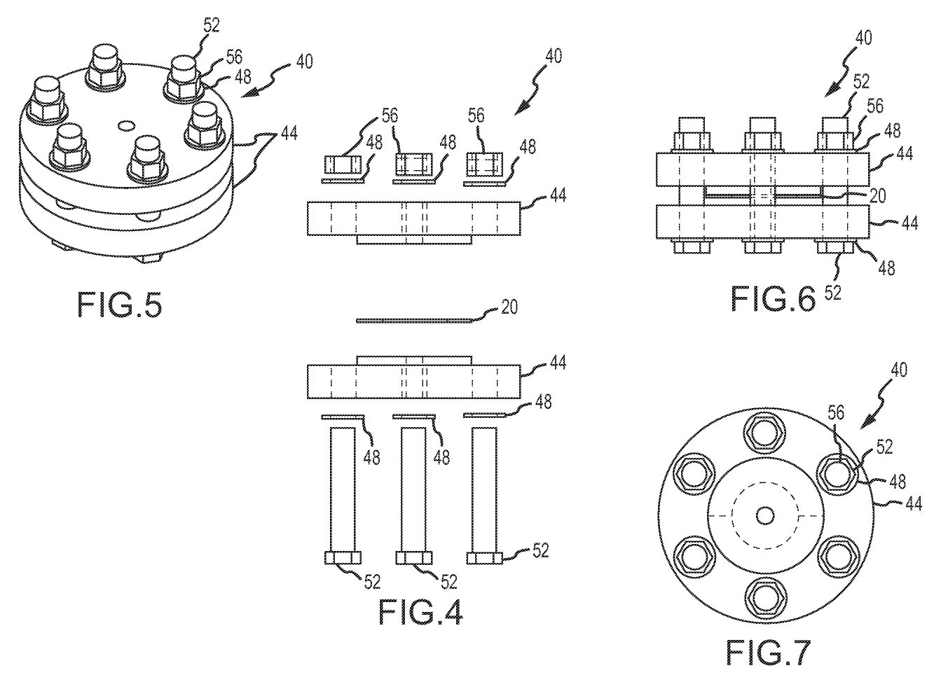

With reference now to FIGS. 4-7, a flange assembly 40 of an embodiment is described. The flange assembly 40, in this embodiment, is a test assembly that may be used to test a gasket 20 under simulated operating conditions in order to verify gasket performance. For example, a coated gasket 20 may have a coating of 100% hexagonal boron nitride. It is desired to test the gasket and coating at a specified bolt load and at a specified temperature to determine if the gasket releases from the flange surfaces after being exposed to the simulated operating conditions for a period of time. In this embodiment, a coated gasket 20 is mounted in flange assembly 40 between two flanges 44. The flanges 44 are secured to one another with washers 48, bolts 52, and nuts 56. The nuts 56 and bolts 52 are tightened to a desired bolt load, and the assembled test assembly is subjected to simulated operating conditions. The flange assembly 40 is removed from the simulated operating conditions, and the two flanges 44 are separated. When the flanges 44 are separated, the force required to separate the flanges 44 is measured, and the residue left on the flange 44 faces that contact the gasket is observed.

Although the technology have been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth). Expressions such as “up,” “down,”, “upper,” “lower,” “horizontal,” “vertical,” “left,” “right,” and the like are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

What is claimed is:

1. A gasket assembly for removable disposition between opposing surfaces, the gasket assembly comprising:
a gasket body having a plurality of mating surfaces;
a release agent layer adhered to at least a portion of one or more of the gasket mating surfaces; the release agent comprising a quantity of hexagonal boron nitride.

2. The gasket assembly of claim 1 wherein the release agent is further comprised of a quantity of a material from the family of materials that include: silicates, oxides, phyllosilicates, and clays.

3. The gasket assembly of claim 1 wherein the release agent is further comprised of a quantity of a material from the family of materials that includes: thermoplastic, fluoropolymer, thermoset, naturally occurring polysaccharide media, and waxes.

4. The gasket assembly of claim 2 wherein the release agent is further comprised of a quantity of a material from the family of silicate materials that include colloidal silica, potassium silicate, sodium silicate, and lithium silicate.

5. The gasket assembly of claim 2 wherein the release agent is further comprised of a quantity of a material from the family of phyllosilicate materials that include talc, mica, and vermiculite.

6. The gasket assembly of claim 2 wherein the release agent is further comprised of a quantity of a material from the family of oxide materials that include aluminum oxide, zirconium oxide, silicon oxide, and magnesium oxide.

7. The gasket assembly of claim 2 wherein the release agent is further comprised of a quantity of a material from the family of clay materials that include kaolin, bentonite, and halloysite).

8. The gasket assembly of claim 1 wherein the release agent is further comprised of a quantity of a surfactant from the family of surfactants that includes: anionic and nonionic copolymers, alcohols, alkyl polyethylene oxides, and alkyl polyglucosides.

9. The gasket assembly of claim 1 wherein the release agent is comprised of approximately 0.01% to 100% hexagonal boron nitride by dry volume.

10. The gasket assembly of claim 9 wherein the release agent is comprised of approximately 0% to 80% binding agent and/or filler by dry volume.

11. The gasket assembly of claim 10 wherein the release agent is comprised of approximately 0% to 40% surfactant by dry volume.

12. The gasket assembly of claim 1 wherein the release agent is provided as a diluted aqueous dispersion, comprising approximately:
(a) 2.5% hexagonal boron nitride by volume;
(b) 0.3% binder material by volume; and
(c) 1% surfactant by volume.

13. The gasket assembly of claim 12 wherein the release agent is provided as a dry coating applied to a gasket material, comprising approximately:
(a) 66% to 90% hexagonal boron nitride by volume;
(b) 7% to 10% binder material by volume; and
(c) 0% to 26% surfactant by volume

14. The gasket assembly of claim 1 wherein the release agent is provided as a diluted aqueous dispersion, comprising approximately:
(a) 40% hexagonal boron nitride by volume; and
(b) 60% water by volume.

15. The gasket assembly of claim 14 wherein the release agent is provided as a dry coating applied to a gasket material, comprising approximately 100% hexagonal boron nitride by volume

16. The gasket assembly of claim 1 wherein the release agent is provided as a diluted aqueous dispersion, comprising approximately:
(a) 25% hexagonal boron nitride by volume;
(b) 20% inorganic clay filler material by volume; and
(c) 5% silicate binder material by volume.

17. The gasket assembly of claim 16 wherein the release agent is further comprised of distilled water.

18. The gasket assembly of claim 17 wherein the release agent contains 0% surfactant by volume.

19. The gasket assembly of claim 17 wherein the release agent is provided as a dry coating applied to a gasket material, comprising approximately:
(a) 50% hexagonal boron nitride by volume;
(b) 40% inorganic clay filler material volume; and
(c) 10% silicate binder material by volume

20. A method of fabricating a gasket assembly, the method comprising:
providing a sheet of gasket material;
applying a layer of a release agent comprising a quantity of hexagonal boron nitride to a surface of the sheet of gasket material; and
forming one or more gaskets from the sheet of gasket material.

21. The method of claim 20 wherein said release agent is applied to the sheet of gasket material as a release agent dispersion that comprises a quantity of water.

22. The method of claim 21 further comprising:
evaporating a quantity of the water from the release agent dispersion, whereby a layer of release agent adheres to the sheet of gasket material.

23. The method of claim 20 wherein the release agent is further comprised of a quantity of a material from the family of materials that include: silicates, oxides, phyllosilicates, and clays.

24. The method of claim 20 wherein the release agent is further comprised of a quantity of a material from the family of materials that include: thermoplastic, fluoropolymer, thermoset, naturally occurring polysaccharide media, waxes.

25. The method of claim 21 wherein the release agent is comprised of approximately 0.01% to 100% hexagonal boron nitride by dry volume.

26. The method of claim 25 wherein the release agent is comprised of approximately 0% to 80% binding agent and/or filler by dry volume.

27. The method of claim 26 wherein the release agent is comprised of approximately 0% to 40% surfactant by dry volume.
